(19) United States
(12) Patent Application Publication
(10) Pub. No.: US 2008/0192099 A1
(43) Pub. Date: Aug. 14, 2008

(54) Non-step apparatus for adjusting the height of a set of paper pressing wheels used in a large-scale UV ink-jet printer

(75) Inventors: Hsien-Chang Lin, Hsi Chih City (TW); Meng-Chou Hsieh, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/704,384

(22) Filed: Feb. 9, 2007

(51) Int. Cl. B41J 2/01

(52) U.S. Cl. 347/101

(57) ABSTRACT

A non-step apparatus for adjusting the height of a set of paper pressing wheels disposed on at least one side of a large-scale UV ink-jet printer, comprising a turnable handle and a driving device, wherein one end of the driving device is connected with a pressing bar which can control the movement of the set of paper pressing wheels, and the other end is connected with the turnable handle so that the height of the set of paper pressing wheels can be adjusted via the movement of the pressing bar moved by rotating the turnable handle.

### FIELD OF THE INVENTION

The present invention relates to an apparatus for adjusting the height of a set of paper pressing wheels and, more particularly, to a non-step apparatus for adjusting the height of a set of paper pressing wheels used in a large-scale UV ink-jet printer for exerting appropriate pressure on materials according to different properties of the materials without damaging the materials.

### BACKGROUND OF THE INVENTION

With the prosperity of commercial activities, it is a critical point that how to make goods the focus in a market. Therefore, the method to attract customers' attention becomes the key point in marketing goods.

In order to promote different merchandises to a big audience, many ways are adopted to achieve this goal. For example, people may advertise their goods via displaying advertisements on a stage background or on the surface of the body of various vehicles outdoors. Besides, people also may advertise their goods by laying out the goods, window-displaying the goods, or using decorative pictures indoors.

For the advertising the merchandises' purpose, a large-scale UV ink-jet printer is usually utilized, wherein the printer comprises at least one printing structure, which can be moved horizontally on a transverse orbit to print on the surface of different materials including paper.

During the printing process, it is necessary to exert an appropriate pressure on a material and then the material can be advanced stably on a roller of a large-scale UV inkjet printer. FIG. 5 is a perspective view showing a conventional paper-holding device “A” disposed on a large-scale UV ink-jet printer, and the paper-holding device “A” comprises a pressing bar “A1” and a set of paper pressing wheels “A2”. In order to prevent a material “B” on a roller “C” from damaging as a result of exerting too much a pressure directly on the material “B”, the paper-holding device “A” performs by means of exerting a pressure to the set of paper pressing wheels “A2” via the pressing bar “A1”, and then the pressure is continuously exerted on the material “B” via the set of paper pressing wheels “A2”. The relatively small contact area between the material “B” and the set of paper pressing wheels “A2” can prevent the material B from directly being exerted by too much a pressure thereon.

With different materials of different properties, the appropriate pressure degree varies. Thereby, although the contact area between the material and the set of paper pressing wheels is relatively small, the set of paper pressing wheels may still exert too great a pressure on a material as a result of failing to adjust the height of the set of paper pressing wheels continuously. Besides, variety kinds of materials can be printed in a large-scale UV ink-jet printer, such as acrylic, corrugated board, canvas, aluminum, steel, tiles, plastic, wood, leather, glass, mesh, fabric, vinyl and many more, so it is even more necessary for operators to adjust the exerting pressure according to the different properties (such as the degree of hardness, thickness, or others) of the materials. Or, a material may be damaged if it is given an inappropriately great pressure and thus it will fail to be printed successively. However, up to the present days, no non-step apparatus for adjusting the height of the set of paper pressing wheels has been invented.

Therefore, there is a need to adjust the pressure the paper-holding device exerting on certain materials according to their different properties (such as the degree of hardness, thickness, or others) in order to overcome the shortcomings of the prior art and prevent the possible damage to the materials.

### SUMMARY OF THE INVENTION

The main object of the present invention is to provide a non-step apparatus having a driving device for adjusting the height of a set of paper pressing wheels used in a large-scale UV ink-jet printer. The pressure exerted on a material can be altered by adjusting the height of the set of paper pressing wheels of a paper-holding device according to the property (such as the degree of hardness, thickness, or others) of the material.

In order to achieve the aforementioned object, the present invention provides a non-step apparatus for adjusting the height of a set of paper pressing wheels disposed on at least one side of a large-scale UV ink-jet printer, which comprises a turnable handle and a driving device, wherein one end of the driving device is connected with a pressing bar of the printer and the other end is connected with the turnable handle, so that the height of the set of paper pressing wheels can be adjusted via the movement of the pressing bar moved by rotating the turnable handle. Thereby, a material can be held by an appropriate pressure according to its property.

Other objects, advantages and novel features of this invention will be obvious with the following detailed description when taken in conjunction with the accompanying drawings.

### BRIEF DESCRIPTION OF THE DRAWINGS

FIG. 1 is a perspective view showing a non-step apparatus for adjusting the height of a set of paper pressing wheels of a first embodiment according to the present invention, wherein the non-step apparatus is disposed on a large-scale UV ink-jet printer;

FIG. 2 is a schematic view showing the using state of the non-step apparatus in FIG. 1 disposed on a large-scale UV ink-jet printer;

FIG. 3 is a schematic view showing the using state of a non-step apparatus for adjusting the height of a set of paper pressing wheels of a second embodiment of the present invention, wherein the non-step apparatus is disposed on a large-scale UV ink-jet printer;

FIG. 4 is a schematic view showing the linking state between the two apparatuses in FIG. 3 disposed on two sides of the large-scale UV ink-jet printer; and

FIG. 5 is a perspective view showing a conventional paper-holding device disposed on a large-scale UV ink-jet printer.

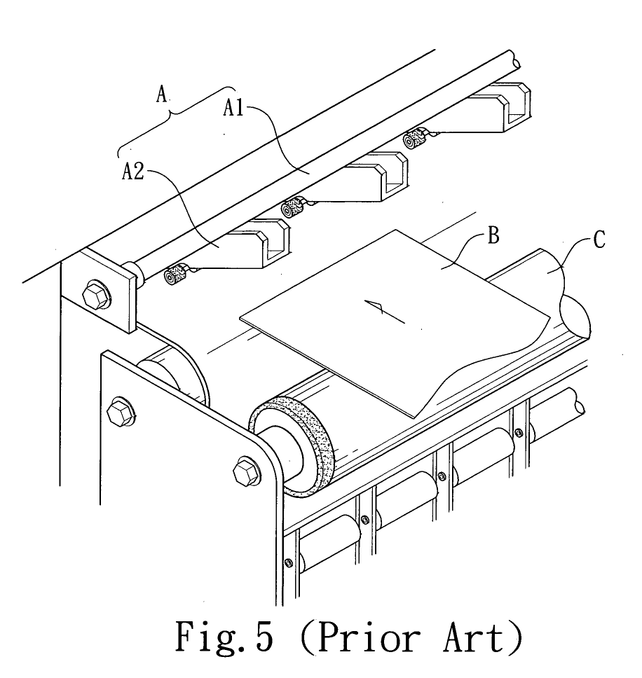

### DETAILED DESCRIPTION OF THE PREFERRED EMBODIMENT

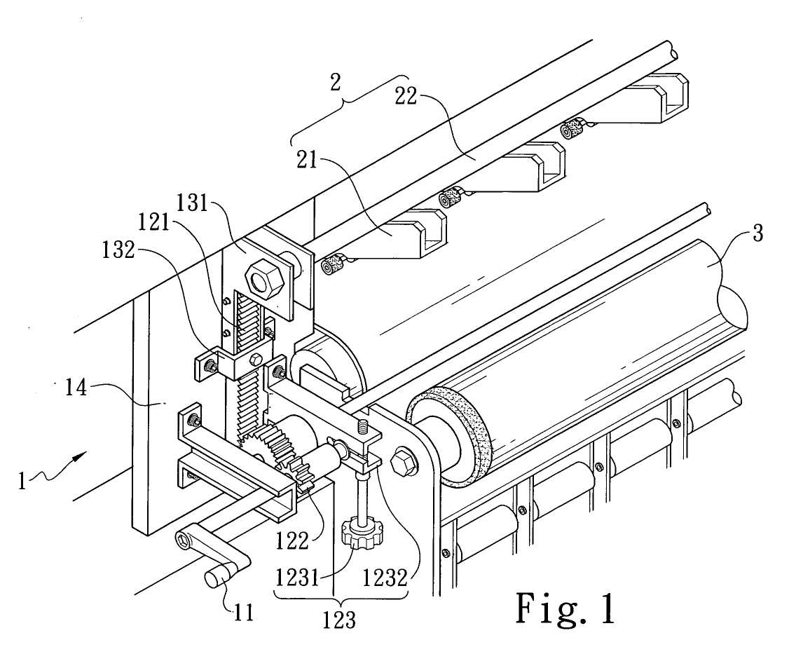

FIG. 1 is a perspective view showing a non-step apparatus 1 for adjusting the height of a set of paper pressing wheels of a first embodiment of the present invention, wherein the non-step apparatus is disposed on a large-scale UV ink-jet printer. As shown in FIG. 1, the non-step apparatus 1 for adjusting the height of a set of paper pressing wheels 21 is fixed via a fixing plate 14 on one side of the printer and comprises a turnable handle 11 and a driving device 12, wherein one end of the driving device 12 is connected with a pressing bar 22 of the printer and the other end is connected with the turnable handle 11 so that the height of the set of paper pressing wheels 21 can be adjusted via the movement of the pressing bar 22 moved by rotating the turnable handle 11.

The driving device 12 includes a toothed rack 121, two gears 122, and a locking member 123. The toothed rack 121 of the driving device 12 is in pivotal connection with the pressing bar 22 of a paper-holding device 2 via a first fixing member 131 and is fixed on the fixing plate 14 of the large-scale UV ink-jet printer via a second fixing member 132. The turnable handle 11 is connected with the toothed rack 121 through the gears 122. When the turnable handle 11 is rotated, the toothed rack 121 is moved vertically via the movement of the gears 122. With the vertical movement of the toothed rack 121, the pressing bar 22 is moved correspondingly and then the set of paper pressing wheels 21 below the pressing bar 22 is moved to an optimal position, that is, a position that the set of paper pressing wheels 21 can exert an appropriate pressure on the material. In practice, when the turnable handle 11 is rotated clockwise, the pressing bar 22 is moved downward accordingly and the distance between the material and the set of paper pressing wheels 21 is decreased. When the turnable handle 11 is rotated counter-clockwise, the distance between the material and the set of paper pressing wheels 21 is increased accordingly.

Moreover, in order to prevent the set of paper pressing wheels 21 from leaving the optimal position as a result of the reverse movement of the gears 122 by accident, for example, the turnable handle 11 may be rotated accidentally. The locking member 123 comprises a locking bar 1231 and an interlocking piece 1232 and is provided for preventing the possible reverse movement of the gears 122 mentioned above. When the optimal position of the set of paper pressing wheels 21 is determined by rotating the turnable handle 11, the reverse movement of the gears 122 is blocked by locking the interlocking piece 1232 by rotating the locking bar 1231.

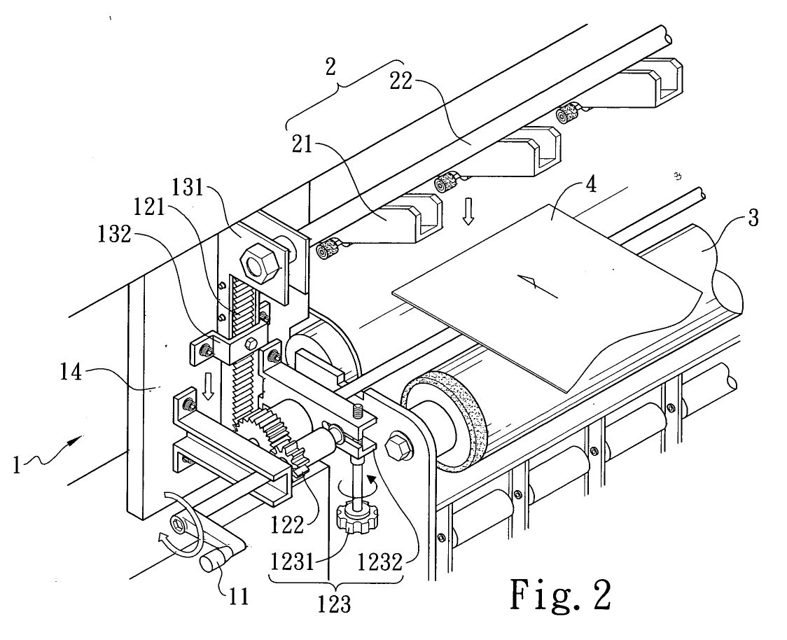

As shown in FIG. 2, according to the property (such as the degree of the hardness, thickness, or others) of a material 4, a user can alter the pressure exerted on the material 4 via adjusting the height of the paper-holding device 2 by altering the height of the pressing bar 22 and the set of paper pressing wheels 21 by moving the toothed rack 121 actuated by rotating the turnable handle 11 through the gears 122.

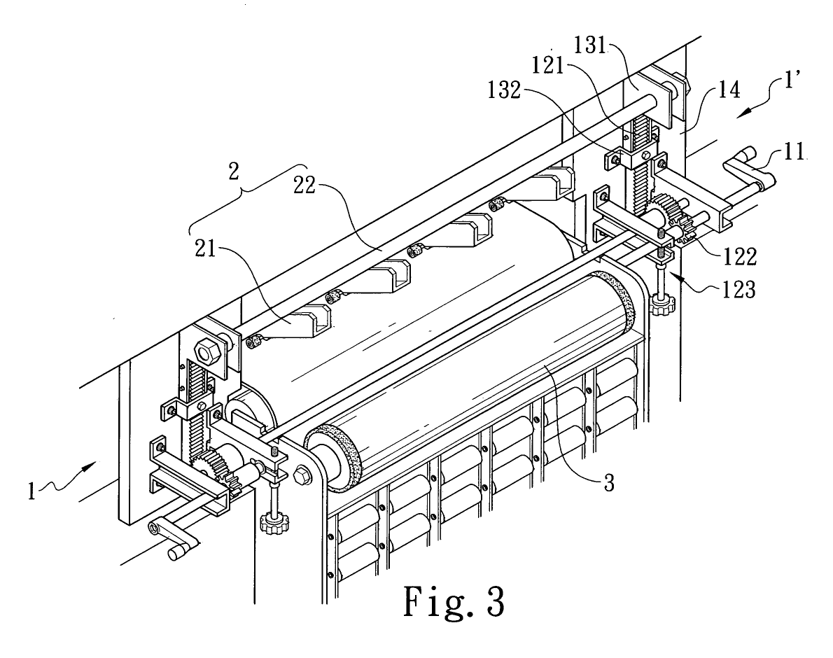

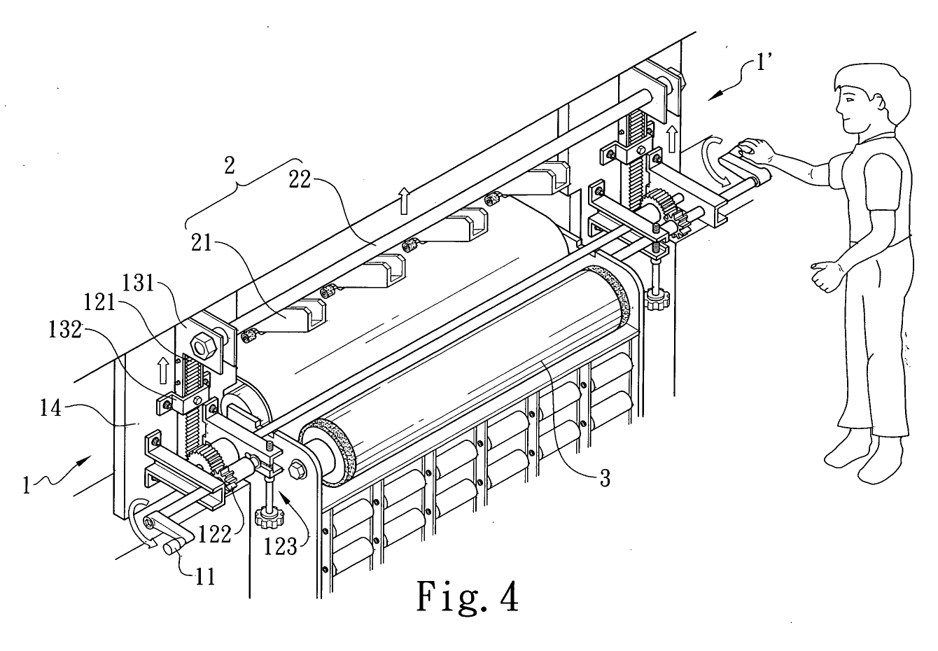

Furthermore, in order to become more practical utility, as shown in FIG. 3, each end of the large-scale UV ink-jet printer is disposed with one non-step apparatus 1, 1′. FIG. 4 is a schematic view showing the linking state between the two apparatuses in FIG. 3 disposed on two sides of the large-scale UV ink-jet printer. When a user rotates the turnable handle 11 of the non-step apparatus 1′, the other non-step apparatus 1 disposed on the other end of the printer will be moved simultaneously. This designation has two purposes. First, the large-scale UV printer has one non-step apparatus 1, 1′ on each end and one non-step apparatus 1 will be simultaneously moved via the actuation of the other one 1′. Thereby, one can adjust the height of the paper-holding device 2 by rotating the turnable handle 11 of the non-step apparatus in either end of the large-scale UV printer without the need of changing one's position. Second, a right-handed or left-handed user can choose either end for his convenience.

Accordingly, the present invention can provide a non-step apparatus having a driving device for adjusting the height of a paper-holding device used in a large-scale UV ink-jet printer. The height of a set of paper pressing wheels of a paper-holding device can be adjusted by the driving device according to different properties (such as the degree of hardness, thickness, or others) of the materials. Thereby, the materials can be printed without damage resulting from exerting an inappropriate pressure.

Although the embodiments of the present invention have been described in detail, many modifications and variations may be made by those skilled in the art from the teachings disclosed hereinabove. Therefore, It should be understood that different modifications and variations could be made from the teaching disclosed above by the people familiar in the art, without departing the spirit of the present invention.

What is claimed is:

1. A non-step apparatus for adjusting the height of a set of paper pressing wheels disposed on at least one side of a large-scale UV ink-jet printer, comprising:
a turnable handle; and
a driving device, wherein one end of the driving device is in pivotal connection with a pressing bar, and the other end of the driving device is connected with the turnable handle, so that the height of the set of paper pressing wheels can be adjusted via the movement of the pressing bar moved by rotating the turnable handle.

2. The non-step apparatus as claimed in claim 1, wherein the driving device further comprises:
a toothed rack in connection with the pressing bar; and
at least one gear for connecting the toothed rack with the turnable handle; when the toothed rack is moved vertically by rotating the turnable handle, the height of the pressing bar will be altered correspondingly so that the height of the set of paper pressing wheels can be adjusted.

3. The non-step apparatus as claimed in claim 2, wherein the driving device further includes a first fixing member for providing pivotal connection between the toothed rack and the pressing bar.

4. The non-step apparatus as claimed in claim 2, wherein the driving device further includes a second fixing member for fixing the toothed rack.

5. The non-step apparatus as claimed in claim 1, wherein the driving device further includes a locking member.

6. The non-step apparatus as claimed in claim 5, wherein the locking member further includes a locking bar and at least an interlocking piece, and the possible reverse movement of the gear is blocked by locking the interlocking piece via rotating the locking bar.

7. The non-step apparatus as claimed in claim 1, wherein the non-step apparatus is fixed on at least one side of the printer via a fixing plate.
